(19) United States
(12) Patent Application Publication
(10) Pub. No.: US 2003/0081249 A1
(43) Pub. Date: May 1, 2003

(54) Easy printing of visual images extracted from a collection of visual images

(75) Inventors: Subutai Ahmad, Palo Alto, CA (US); Jonathan R. Cohen, San Francisco, CA (US); Sai-Wai Fu, Los Altos Hills, CA (US)

Correspondence Address: David R. Graham, 1337 Chewpon Avenue, Milpitas, CA, 95035, US

(73) Assignee: YesVideo, Inc.

(21) Appl. No.: 10/227,022

(22) Filed: Aug. 21, 2002

Related U.S. Application Data
(60) Provisional application No. 60/314,225, filed on Aug. 21, 2001.

(51) Int. Cl. B41J 1/00; G06F 15/00

(52) U.S. Cl. 358/1.15

(57) ABSTRACT

The invention facilitates producing prints of visual images extracted from a collection of visual images (e.g., visual recording, collection of still visual images). The invention facilitates producing the prints by automatically identifying visual images to be printed in response to the receipt of a request from a user to produce prints from the collection of visual images. The invention can further facilitate producing the prints by enabling the request to be effected by a single input to a user input apparatus. The request to produce prints can be communicated via a network to a print production site that produces the prints and provides the prints to the user. The request to produce prints can also cause the visual images, the collection of visual images and/or indices identifying the visual images, to be stored on portable data storage medi(a) together with, if necessary or desirable, computer program(s) and/or data structure(s) for producing prints of the visual images.

### BACKGROUND OF THE INVENTION

1. Field of the Invention

This invention relates to producing prints of visual images extracted from a collection of visual images and, in particular, to producing prints of visual images extracted from a large collection of visual images, such as a visual recording or a large collection of still visual images.

2. Related Art

There are a large number of products aimed at helping consumers interact with (e.g., view, digitize, edit, organize, share) their home video (or other multimedia content) using a personal computer (e.g., desktop computer, laptop computer). Those computer based products are typically very labor intensive and require a significant amount of time to manipulate the video into the desired final form.

An increasing number of consumers want to interact with their home video (or other multimedia content) using a television-based platform (e.g., television or home theater system). Very little technology has been developed to enable consumer interaction with home video using a television-based platform. Current approaches to enabling interaction with home videos on a television-based platform are primarily restricted to tape-based playback mechanisms. These approaches are highly restricted because: 1) tape is a linear playback mechanism, 2) tape is slow to rewind and fast forward, 3) tape quality degrades rapidly with usage and time, and 4) it is very difficult to extract still visual images from tape. The advent of digital media has opened up new possibilities for interacting with home video.

Additionally, user input devices (e.g., television remote control devices) used with television-based platforms are very different from those used with computers (e.g., keyboards, mice). In particular, the remote control devices used with television-based systems typically afford a more limited range of user input than that enabled by a keyboard and mouse commonly used with a computer. Thus, a difficulty in developing technology for interacting with home video using a television-based platform is that the user input required for effecting such interaction should be kept relatively simple.

There exist services for facilitating printing of digital still photographs. However, it can be desirable to extract individual visual images from a collection of visual images (e.g., extract individual visual images from a home video or a large collection of still visual images) and print those individual visual images. Currently, however, printing of such images is difficult and time consuming. Consequently, it would be desirable to facilitate the printing of such images.

### SUMMARY OF THE INVENTION

The invention facilitates producing prints of visual images extracted from a collection of visual images, in particular, a large collection of visual images, such as a visual recording or a large collection of still visual images. The invention facilitates producing the prints by automatically identifying, in response to a request from a user, visual images to be printed from the collection of visual images. The invention can further facilitate producing the prints by enabling the request to be effected by a single input to a user input apparatus. The request to produce prints can be communicated (this can occur automatically in response to the request) via a network to a print production site that produces the prints and provides the prints to the user. The request to produce prints can also cause the identified visual images, the collection of visual images and/or indices identifying the visual images, to be stored on a portable data storage medium or media, such as one or more DVDs or CDs (again, this can occur automatically in response to the request). One or more computer programs and/or data structures for producing prints of the identified visual images can also be stored on the portable data storage medium or media. The invention can automatically select and extract visual images to be printed from the collection of visual images. The selection of visual images can be based on one or more characteristics of the collection of visual images (e.g., the quality of each of the visual images in the collection of visual images, identification of keyframes in the collection of visual images.)

In one embodiment of the invention, prints of visual images extracted from a collection of visual images are produced by 1) receiving a request from a user to produce prints from the collection of visual images, 2) automatically identifying, in response to the request, visual images to be printed from the collection of visual images, and 3) communicating the request to produce the prints via a network to a print production site. The request, as communicated to the print production site, identifies a client system used by the user to make the request. The request, as communicated to the print production site, also includes the visual images, an identification of the visual images (e.g., indices identifying the locations of the visual images in the collection of visual images) and/or the collection of visual images. The request, as communicated to the print production site, can also include user-specified parameter values regarding the selection of visual images. The collection of visual images, the visual images and/or indices identifying the locations of the visual images in the collection of visual images can be stored at the client system (e.g., on a hard drive or on a portable data storage medium or media) and/or at the print production site. The prints are produced at the print production site and provided to the client system. The visual images can be selected and extracted at the client system, selected and extracted at the print production site, selected at the client system and extracted at the print production site, previously selected and then extracted at either the client system or the print production site, or previously selected and extracted, and then stored at either the client system or the print production site. The print production site can communicate an order identification to the client system via the network after the order is received and approved. The client system can communicate with the print production site to modify the order (e.g., add and/or delete visual images to be printed, request a specified quantity of prints of a specified visual image, change the location for delivery of the prints).

In another embodiment of the invention, prints of visual images extracted from a collection of visual images are produced by 1) receiving a request from a user to produce prints from the collection of visual images, 2) automatically identifying, in response to the request, visual images to be printed from the collection of visual images, and 3) storing the identified visual images, the collection of visual images and/or indices identifying the locations of the identified visual images in the collection of visual images, on a portable data storage medium or media (e.g., one or more DVDs or CDs). One or more computer programs and/or data structures for producing prints of the identified visual images can also be stored on the portable data storage medium or media, if the implementation of the invention makes this necessary or desirable. The user can be enabled to specify one or more parameters regarding the selection of visual images from the collection of visual images, which parameter values can also be stored on the portable data storage medium or media. The visual images can be digitized (if necessary), selected and/or extracted before, at the time of, or after the request. The one or more computer programs and/or data structures can automatically be used, upon insertion of the portable data storage medium or media into a data reading device, to produce prints of the identified visual images. The identified visual images can be extracted (and, depending upon the implementation, selected) at this time. The user can also be enabled at this time to add and/or delete visual images to be printed, and/or request a specified quantity of prints of a specified visual image.

In another embodiment of the invention, prints of visual images extracted from a collection of visual images are produced by 1) receiving a request from a user to produce prints from the collection of visual images, and 2) automatically identifying, in response to the request, visual images to be printed from the collection of visual images. The request can be effected by a single input to a user input apparatus.

### BRIEF DESCRIPTION OF THE DRAWINGS

FIG. 1 is a block diagram illustrating components of a system in which the invention can be used.

FIG. 2 is a flow chart of a method, according to an embodiment of the invention, for printing one or more visual images extracted from a collection of visual images.

### DETAILED DESCRIPTION OF THE INVENTION

The invention facilitates producing prints of visual images extracted from a collection of visual images. In particular, the invention can facilitate producing prints of visual images extracted from a large collection of visual images, such as a visual recording or a large collection of still visual images. The invention facilitates producing the prints by automatically identifying visual images to be printed from the collection of visual images, in response to the receipt of a request from a user to produce prints from the collection of visual images. The invention can further facilitate producing the prints by enabling the request to be effected by a single input to a user input apparatus such as a television type remote control device. The request to produce prints can be communicated (which communication can occur automatically in response to the request) via a network to a print production site that produces the prints and provides the prints to the user. The request to produce prints can also cause the identified visual images, the collection of visual images and/or indices identifying the visual images, to be stored on a portable data storage medium or media, such as one or more DVDs or CDs (again, this can occur automatically in response to the request). One or more computer programs and/or data structures for producing prints of the identified visual images can also be stored on the portable data storage medium or media, if the implementation of the invention makes this necessary or desirable. The invention can automatically select and extract visual images to be printed from the collection of visual images. The selection of visual images can be based on one or more characteristics of the collection of visual images (e.g., the quality of each of the visual images in the collection of visual images, identification of keyframes in the collection of visual images). The automatic identification of visual images to be printed can entail the automatic selection of the visual images, the automatic selection and extraction of the visual images, the automatic extraction of the visual images using indices identifying the locations of the selected visual images in the collection of visual images, or the identification of visual images that are otherwise automatically extracted from the collection of visual images.

In general, the invention can encompass any production of prints of visual images that have been automatically selected (as described elsewhere herein) from a collection of visual images.

The invention can be used to enhance a home theater system (or other audiovisual display system) by facilitating printing of visual images extracted from a collection of visual images. An advantage of the invention is that the invention can be automated to facilitate easy printing of visual images extracted from a collection of visual images. For example, the invention can be implemented with an audiovisual display system (e.g., television, home theater system) to enable printing visual images extracted from a visual collection of visual images using a simple remote control and a small number of inputs (e.g., button clicks) to the remote control,. Thus, the invention has particular utility in enabling non-professionals to print visual images extracted from a collection of visual images, since such users may lack the sophistication, desire or time to otherwise do so.

The invention can make use of two types of data: content data (e.g., visual recording data, still visual image data) used to produced the prints, and metadata which can be used to select visual images for printing. Herein, “metadata” is used as known in the art to refer to data that represents information about the content data. Examples of metadata are described in more detail below. Metadata can be created manually (e.g., specification by the creator of a set of content data of a title for, or a description of, the set of content data). Metadata can also be extracted automatically from a set of content data (e.g., automatic evaluation of the quality of a visual image, automatic determination of scene breaks and/or keyframes in a visual recording).

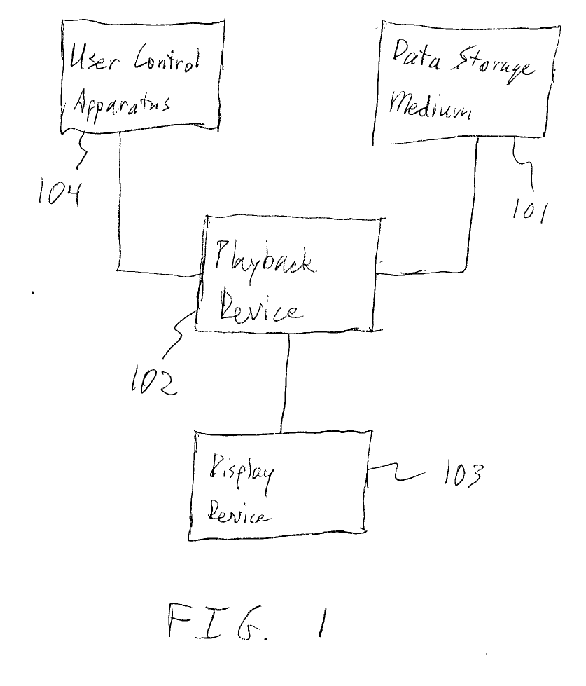

FIG. 1 is a block diagram illustrating components of a system in which the invention can be used. The components of the system illustrated in FIG. 1 can be embodied by any appropriate apparatus, as will be understood by those skilled in the art in view of the description herein. Content data is stored on data storage medium 101. The content data includes visual image data. Metadata can also be stored on the data storage medium 101. The data storage medium 101 can be embodied by any data storage apparatus. For example, the data storage medium 101 can be embodied by a portable data storage medium or media, such as one or more DVDs, one or more CDs, or one or more videotapes. The data storage medium 101 can also be embodied by data storage apparatus that are not portable (in addition to, or instead of, portable data storage medium or media), such as a hard drive (hard disk) or digital memory, which can be part of, for example, a desktop computer or personal video recorder (PVR). Further, the content data can be stored on the data storage medium 101 in any manner (e.g., in any format). A playback device 102 causes content data (some or all of which, as indicated above, can be stored on the data storage medium 101) to be used to produce an audiovisual or visual display on a display device 103. When some or all of the content data is stored on a portable data storage medium or media, the playback device 102 is constructed so that a portable data storage medium can be inserted into the playback device 102. The playback device 102 can be embodied by, for example, a conventional DVD player, CD player, combination DVD/CD player, or computer including a CD and/or DVD drive. The playback device 102 can have included or associated therewith data recording apparatus for causing data to be stored on a portable data storage medium (e.g., a CD or DVD “burner” for storing visual content data on a CD or DVD). The display device 103 can be embodied by, for example, a television or a computer display monitor or screen. A user control apparatus 104 is used to control operation of the playback device 102 and visual display device 103. The user control apparatus 104 can be embodied by, for example, a remote control device (e.g., a conventional remote control device used to control a DVD player, CD player or combination DVD/CD player), control buttons on the playback device 102 and/or visual display device 103, or a mouse (or other pointing device). As described in more detail elsewhere herein, the user control apparatus 104 and/or the playback device 102 (or processing device(s) associated therewith) can also be used to effect printing of visual images from a collection of visual images. A system according to the invention for requesting the production of prints of visual images extracted from a collection of visual images can be implemented using the data processing, data storage and user interface capabilities of the components of the system of FIG. 1, as can be appreciated in view of the description herein.

The invention can advantageously be used, for example, with a home theater system. A home theater system typically includes a television and a digital video playback device, such as a DVD player or a digital PVR. A PVR (such as a Tivo™ or Replay™ device) typically contains a hard drive, video inputs and video encoding capabilities. The digital video playback device can be enhanced with software that reads metadata encoded on a digital data storage medium, which can be useful with some embodiments of the invention, as discussed elsewhere herein. The digital video playback device can also include data storage apparatus for storing a print production computer program. The digital video playback device can include or have associated therewith a DVD or CD burner. The digital video playback device (or other apparatus of the home theater system) can also contain a network connection to the Internet or a local area network (LAN).

Although the invention can advantageously be used with a home theater system, the invention is not limited to use with that platform. In general, the invention can be used with any hardware platform that contains the appropriate devices. For example, the invention can be used with a personal computer, which often includes a video input (e.g., direct video input or a DVD drive), as well as a processor, a hard drive and a display device, and have associated therewith a DVD or CD burner.

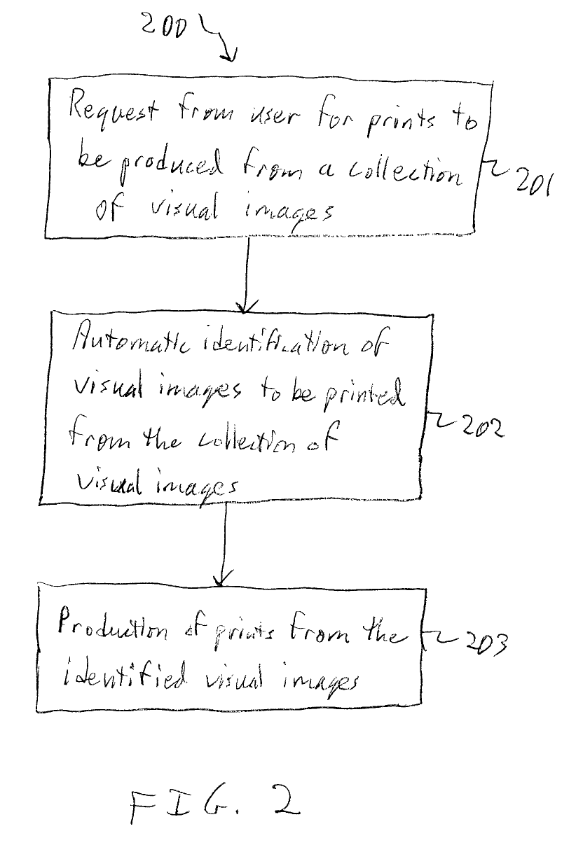

FIG. 2 is a flow chart of a method 200, according to an embodiment of the invention, for producing prints of visual images extracted from a collection of visual images. The method 200 can be implemented, for example, using apparatus as described above. In step 201, a user makes a request (using, for example, a television type remote control device) for prints to be produced from the collection of visual images. In step 202, in response to the request, visual images to be printed from a collection of visual images (e.g., visual recording, large collection of still visual images) are automatically identified. Visual images to be printed must first be selected for printing, then extracted from the collection of visual images. The automatic identification of visual images to be printed from a collection of visual images in the step 202 can encompass selection and extraction of the visual images from the collection of visual images, extraction of the visual images using information identifying the visual images within the collection (e.g., indices identifying the locations of selected visual images in a collection of visual images such as a visual recording), or accessing visual images that have previously been selected and extracted from a collection of visual images. In step 203, once the visual images have been identified, the visual images can be printed. In particular, the invention contemplates communicating the request to produces prints (together with the identified visual images or an identification of those visual images) to an entity or medium that facilitates printing. For example, the request to print the visual images can be communicated via a network to a print production site that produces prints of the visual images, then provides the prints to the user. Or, for example, the request to produce prints can cause the visual images, the collection of visual images and/or indices identifying the visual images, to be stored on portable data storage medi(a) together with, if necessary or desirable, computer program(s) and/or data structure(s) for producing prints of the visual images.

As discussed above, the invention can make use of two types of data to facilitate printing of visual images from a collection of visual images: content data (e.g., visual recording data, still visual image data) and metadata (i.e., data representing information about the content data). As discussed further below, the content data can take a variety of forms and be provided for use in a variety of ways in producing prints of visual images extracted from a collection of visual images. The invention operates on digital content data, which can be obtained directly using a digital data acquisition device (e.g., digital still or video camera) or produced by converting analog content data obtained using an analog data acquisition device (e.g., analog still or video camera) to digital content data using techniques known to those skilled in the art. The metadata can be provided to a system for implementing the invention (having been produced before operation of the invention) or the metadata can be produced by a system according to the invention.

The invention can be used to print visual images from any collection of visual images. For example, the invention can be used to print visual images selected and extracted from a visual recording, such as a videotape. Or, for example, the invention can be used to print visual images selected and extracted from a collection of still visual images (in particular, a large collection of still visual images), such as a collection of digital photographs. A collection of visual images from which the invention can be used to select and extract visual images for printing can also include both visual images from a visual recording and still visual images. Those skilled in the art will readily appreciate that there are other types of collections of visual images with which the invention can be used.

As discussed above, the invention operates on digital content data. Digital visual image data can be obtained in a variety of ways. For example, a user can acquire a visual recording directly in digital form by, for example, recording on to miniDV tape, optical disk or hard drive. Or, for example, a user can digitize analog visual image content and store the digitized visual image content on one or more digital data storage media such as DVD(s), CD-ROM(s) or a hard drive. A user can do this using existing software program(s) on a conventional computer. There also exist cost-effective services for digitizing analog visual image data, as provided, for example, by YesVideo, Inc. of San Jose, Calif.

During or after acquisition or digitization of the visual image data, metadata can be produced regarding the visual image data. The metadata can be stored on a portable data storage medium or media (e.g., one or more DVDs or CDs) together with visual image data. The metadata can be stored in a standard data format (e.g., in one or more XML files). As indicated above, visual image metadata can be created manually (e.g., by being specified by a creator of visual image data or by a user or operator performing processing, such as digitization, of the visual image data) or automatically (e.g., by performing computer analysis of visual image data). Visual image metadata that is typically created manually can include, for example, data representing a title for, a description of, and the name of a creator (e.g., a person or entity who acquired, or caused to be acquired, content data) of a visual image or a collection of visual images. Visual image metadata that is typically created automatically (but can also be created manually) can include, for example, data representing the number of visual images, the locations of visual images within a visual recording (if appropriate), the date of acquisition (capture) of the visual images, the date of digitization of the visual images, the quality of visual images, and image importance values for the visual images, and data identifying the location of scene breaks and/or keyframes in a visual recording. In one embodiment of the invention, visual image metadata is stored in XML format on a DVD or CD together with a visual recording during the capture or digitization process and includes at least data representing the title, description and date of capture of the visual recording, and frame indices corresponding to the visual images of the visual recording determined to have the highest quality.

The quality of a visual image can be determined using any of a variety of methods. For example, visual image quality can be determined using a method as described in commonly-owned U.S. Provisional Patent Application Serial No. 60/306,282, entitled “Autosnap: A Method for Automatically Selecting Still Frames from Video,” filed on Jul. 17, 2001, by Michele Covell et al., or as described in commonly-owned, co pending U.S. patent application Ser. No. 10/198,602, entitled “Automatic Selection of a Visual Image or Images from a Collection of Visual Images, Based on an Evaluation of the Quality of the Visual Images,” filed on Jul. 17, 2002, by Michele Covell et al., the disclosures of which are hereby incorporated by reference herein.

The location of scene breaks and/or keyframes in a visual recording can be identified using any of a variety of methods. For example, a keyframe can be identified as the first (i.e., temporally earliest) frame of a segment of a visual recording. (Segments can be identified, for example, as scenes, i.e., the visual recording content between scene breaks.) A keyframe can also be identified by evaluating the content of a segment of a visual recording and choosing as the keyframe a frame of the segment that is determined to be, based on the evaluation, representative of the content of the segment. For example, keyframes (and scene breaks) can be identified using a method as described in commonly-owned, co-pending U.S. patent application Ser. No. 09/792,280, entitled “Video Processing System Including Advanced Scene Break Detection Methods for Fades, Dissolves and Flashes,” filed on Feb. 23, 2001, by Michele Covell et al., the disclosure of which is hereby incorporated by reference herein. Keyframes can also be identified using a method as described in the above-referenced U.S. Provisional Patent Application Serial No. 60/306,282 or in the above referenced U.S. patent application Ser. No. 10/198,602.

The visual image metadata can be used to select, or prioritize for selection, visual images for printing from a collection of visual images. (Visual images may be prioritized for selection, for example, if a user has requested printing of a specified number of visual images.) For example, each of the visual images of a collection of visual images can be evaluated to determine an “image importance” for the visual image (which can be represented as a score for the visual image), and visual images selected, or prioritized for selection, for printing based on relative image importances. Image importance can be determined in any appropriate manner. For example, image importance can be determined based on an evaluation of the quality of the visual image (i.e., a measurement of image characteristics such as sharpness and/or brightness). Image quality can be determined, for example, as described in the above-referenced U.S. Provisional Patent Application Serial No. 60/306,282 or in the above-referenced U.S. patent application Ser. No. 10/198,602. Image importance can also be determined based on an evaluation of the content of the visual image. Image content can be evaluated by, for example, evaluating the likelihood that a visual image is a keyframe (e.g., giving preference—increasing the image importance score to the first visual image of each scene of a visual recording), as described in the above-referenced U.S. patent application Ser. No. 09/792,280. Image importance can also be determined as a combination of image quality and image content. For example, an image importance score determined by evaluating image quality can be raised or lowered based on whether or not a visual image is a keyframe, or a likelihood that a visual image is a keyframe (raised if a visual image is, or is likely to be, a keyframe). Once the visual images have been evaluated, the visual images can be selected, or prioritized for selection, using any desired method. For example, visual images having an image importance score greater than a specified threshold can be selected for printing. Or, visual images can be prioritized for selection by selecting visual images for printing beginning with the visual image having the highest image importance score and continuing in succession with visual images having the next highest image importance score until a required number of visual images have been selected for printing.

After visual images have been selected to be printed, the visual images are extracted from the collection of visual images. Visual images can be extracted from a visual recording or other collection of visual images using methods known to those skilled in the art.

Depending on the particular implementation of the invention, data regarding the visual images can be stored on a data storage medium or media (e.g., a portable data storage medium or media, such as one or more DVDs or CDs) in different ways. For example, the extracted visual images can be stored together with the visual recording (in any standard visual image format, such as JPEG, BMP, or GIF), or indices to the selected images can be stored with the visual recording to enable the corresponding visual images to be extracted from the visual recording at a later time (e.g., when a user requests prints or at the time of printing). The extracted visual images can also be stored alone. In some embodiments of the invention, the visual recording is stored alone: the visual images are selected and extracted in accordance with the invention when it is desired to produce prints of the selected visual images. The invention can be implemented so that multiple resolutions of each visual image in a collection of visual images are stored, e.g., a low resolution version for displaying the visual images as thumbnails, a medium resolution version for displaying the visual images on a television screen, and a high resolution version for printing the visual images.

The invention can be implemented so that, from a user's perspective, selecting a set of visual images to print using the invention is extremely straightforward. (Herein, “user” refers to a person that desires to print visual images according to the invention.) This is an important advantage of the invention which is made possible through the use of metadata (as described in more detail elsewhere herein) and by implementing the invention so that many aspects of printing visual images are performed automatically without user intervention. In particular, the invention can be implemented so that a user need only take minimal action to cause visual images to be printed. Further, the user input(s) required to print a set of visual images extracted from a collection of visual images can be provided using a standard remote control.

For example, in one embodiment, the invention is implemented so that a user need only make the choice to decide to print visual images extracted from a collection of visual images. To enable printing of visual images extracted from a collection of visual images, the user inserts into an appropriate playback device of an audiovisual display system (such as a conventional DVD player, CD player, combination DVD/CD player, or CD or DVD drive of a computer) a portable data storage medium (such as a DVD or CD) on which is stored a collection of visual images. (The portable data storage medium can also have stored thereon a set of visual images that have been extracted from the collection of visual images, in accordance with the description elsewhere herein.) The audiovisual display system can be implemented so that when the portable data storage medium is inserted into the playback device, the audiovisual display system detects the type of data (i.e., content data and/or metadata in accordance with the invention) stored on the portable data storage medium and displays a user interface mechanism that indicates various operations that can be performed with respect to a collection of visual images stored on the portable data storage medium, including printing of visual images extracted from a collection of visual images in accordance with the invention (e.g., a display menu including a menu option denoted by “Get Prints” or similar text). Appropriate input to the user interface mechanism (e.g., selection of the Get Prints menu option) by the user causes, in accordance with one of the particular embodiments of the invention described elsewhere herein, printing of a set of visual images extracted from the collection of visual images (e.g., printing of the “best” visual images, which can be the visual images having the highest “image importance,” determined as discussed elsewhere herein). (If multiple collections of visual images, e.g., multiple visual recordings, can be stored on a single portable data storage medium, this embodiment of the invention can further be implemented so that, upon input to the user interface mechanism to request printing of a set of visual images extracted from a collection of visual images, a new menu is displayed including a list of collection of visual images; selection of a collection of visual images by the user automatically causes printing of visual images from the selected collection of visual images to begin.)

In a further embodiment, the invention is implemented so that, in addition to specifying printing of visual images extracted from a collection of visual images, the user can select the number of visual images, N, to be printed. The invention automatically selects N visual images for printing in accordance with a predetermined criterion or criteria. For example, the invention can automatically select the N visual images with highest importance value as the set of visual images to be printed. In a still further embodiment, the invention is implemented so that the user can specify the predetermined criterion or criteria used to automatically select the N visual images. For example, the user can be enabled to specify choosing visual images having the highest quality or visual images that have been identified as keyframes. Additionally, if the invention is implemented so that more than one collection of visual images can be available at a time for selection of visual images for printing, the user is enabled to select the collection of visual images from which visual images are to be selected for printing.

In another further embodiment, the invention is implemented so that, after specifying printing of visual images extracted from a collection of visual images, but before the visual images are printed, the user can review the visual images to tailor (i.e., add and/or delete) the visual images to be printed. For example, the invention can be implemented to enable the user to review a set of visual images automatically selected for printing in accordance with the invention (e.g., the set of N images having the highest importance) and decide whether to print each one. The invention can be further implemented to enable the user to review other visual images from the collection of visual images and select those visual images, as desired, to be added to the set of visual images to be printed. Since the number of visual images in many collections of visual images (e.g., typical visual recordings) will be very large, this can be done, for example, by using the method for selecting the original set of visual images, but with loosened constraints. Additionally or alternatively, this can also be done, for example, by using a different method for selecting visual images from the collection of visual images (e.g., if the original set of visual images was selected based on quality, new visual images can be selected based on identification as a keyframe). Further, if the collection of visual images is not too large (e.g., a collection of still visual images of manageable size), the invention can be implemented so that user can review all of the visual images in the collection.

In an alternative embodiment, the invention is implemented so that a portable data storage medium has stored thereon a collection of visual images and one or more computer programs for effecting printing of visual images in accordance with the invention. The portable data storage medium can also have stored thereon a set of visual images that have been extracted from the collection of visual images (in accordance with the description elsewhere herein). Alternatively, the one or more computer programs stored on the portable data storage medium are implemented to enable extraction of visual images from the collection of visual images (again, in accordance with the description elsewhere herein). The user need do nothing other than insert the portable data storage medium into a playback device: after insertion of the portable data storage medium, the system automatically causes printing of a set of visual images extracted from the collection of visual images (depending on the implementation, the visual images may also be extracted from the collection of visual images at this time).

The invention enables a number of ways to print the visual images selected from a collection of visual images. For example, in one embodiment of the invention, a system (for convenience, referred to hereinafter as the “client system”) in which the invention is used (e.g., a home theater system) is connected to a network (e.g., the Internet, a local area network). As described further below, the client system communicates with another network site (for convenience, referred to hereinafter as the “print production site”) to cause printing of selected visual images from a collection of visual images in a manner that requires little effort on the part of the user. This embodiment of the invention can be particularly implemented in a variety of ways, as described further below, but, in general, the user inputs a request to the client system for production of prints of selected visual images, the client system communicates that request over the network to the print production site, and the print production site produces prints of the selected visual images and sends the prints to the user.

The request communicated by the client system to the print production site includes an identification of the client system (including relevant information regarding the client system, such as the address at which the client system is located). The client system identifier is used by the print production site to identify where the prints are to be sent. The client system identifier can also be used by the print production site for billing the user.

The invention can be implemented so that the request communicated from the client system to the print production site includes the visual images for which prints are to be produced. The visual images for which prints are to be produced can be identified and extracted at the time the user inputs the request to the client system, identified before the time of the user request and extracted at the time of the user request, or identified and extracted before the time of the user request. For example, in the last case, visual images can be selected and extracted from a visual recording and stored together with the visual recording on a portable data storage medium or media (e.g, one or more DVDs or CDs). For example, YesVideo, Inc. of San Jose, Calif. provides a service for receiving an analog videotape from a customer, digitizing the analog videotape and providing the digitized visual recording to the customer on one or more DVDs or CDs; as part of this service, visual images can be selected from the digitized visual recording data (using, for example, methods as described herein for selecting visual images from a collection of visual images), extracted and stored on the DVDs or CDs together with the digitized visual recording.

The invention can also be implemented so that the request includes the collection of visual images. The visual images to be printed can be selected and extracted from the collection of visual images at the print production site. Or, if the visual images have already been selected (either by the client system or prior to storage of the collection of visual images at the client system) and indices identifying the locations of the selected visual images in the collection of visual images are stored at the client system, the request can further include the indices and only the extraction of the visual images performed at the print production site. The invention can also be implemented so that the request includes both the collection of visual images and the selected visual images. Further, if the invention is implemented to enable user specification of parameter(s) regarding the selection of visual images from the collection of visual images, the request also includes data representing those parameter specifications.

The invention can also be implemented so that the collection of visual images and/or the extracted selected visual images are stored at the print production site. In that case, it is not necessary for the request communicated from the client system to the print production site to include the visual images or the collection of visual images. However, the request must include an identification of the visual images or the collection of visual images. If the request identifies the collection of visual images, the request may also include data representing specification of parameter(s) regarding the selection of visual images from the collection of visual images.

After the request for production of prints is received by the print production site, the print production site can communicate an order identification over the network to the client system. The client system can be implemented to produce a confirmation display upon receipt of the order identification, stating, for example, that the prints have been ordered and that they will arrive within a specified period of time. The order identification can also be used to refer to the order in future communications between the client system and print production site. The print production site produces the prints of the selected visual images and mails the prints to the user.

The invention can further be implemented so that the confirmation display (discussed above), includes, for example, the order identification, an identification of the network location of the print production site, such as a URL (to facilitate future communication with the print production site via the network), and a time limit for finalizing the order. Before expiration of the time limit, the user can access the print production site via the network (e.g., a Web page for the print production site), using the client system or other apparatus (e.g., desktop computer, laptop computer, cell phone, personal digital assistant) that can communicate with sites on the network, to modify one or more aspects of the order. The order identification is communicated to the print production site, which then presents a menu of options for modifying the aspects of the order. Such options can be fairly standard and comparable to, for example, the choices available when ordering prints from a photo sharing web site, such as that operated by Ofoto™. For example, the user can be allowed to add or delete visual images to be printed, request a particular quantity of any print, and change the shipping destination of the prints.

The invention can also be implemented so that the title and/or other textual description of the collection of visual images are printed, either on a package in which the prints are mailed to the user or on the picture itself (front or back).

In another embodiment of the invention, a system in which the invention is used (e.g., a home theater system) includes data recording apparatus (e.g., a CD or DVD “burner”) for causing data to be stored on a portable data storage medium (or media), such as a CD or DVD. One or more collections of visual images (e.g., visual recording(s)) from which visual images can be selected for printing can be stored on a data storage medium (or media), such as a hard drive, of the system. Upon user input to the system requesting production of prints of selected visual images of a collection of visual images, the system automatically uses the data recording apparatus to store data on the portable data storage medium that enables the selected visual images to be easily (e.g., automatically) printed later when the portable data storage medium is inserted into an appropriate data reading device that enables access to the data stored on the portable data storage medium. For example, the selected visual images (and associated metadata, if necessary or desirable) can be stored on the portable data storage medium. Or, for example, the collection of visual images can be stored on the portable data storage medium together with indices identifying the locations of the selected visual images in the collection of visual images. Or, for example, the collection of visual images can be stored on the portable data storage medium together with the selected visual images. Or, for example, the collection of visual images can be stored on the portable data storage medium alone; the visual images to be printed are selected later, when the portable data storage medium is inserted into the data reading device. Depending on the particular implementation of the invention, the visual images can be digitized (if necessary), selected (using method(s) described elsewhere herein) and/or extracted before, at the time of, or after (i.e., at the time of later use of the portable data storage medium to produce prints) the request. (As with other embodiments of the invention, this embodiment of the invention can be implemented so that a user is enabled to specify one or more parameters regarding the selection of visual images from the collection of visual images.) This embodiment of the invention can also be implemented so that the system automatically causes a print production computer program stored by the system (e.g., a Windows executable file stored in an EPROM) to be stored on the portable data storage medium, if the use of such computer program is necessary or desirable in effecting production prints of the selected visual images. After the portable data storage medium has been “burned” (i.e., the data—and, if applicable, print production computer program) that enables the selected visual images to be printed when the portable data storage medium is inserted into a data reading device), the portable data storage medium can then be used with any apparatus (e.g., computer) including an appropriate data reading device (e.g., CD or DVD drive) and a printer to produce prints from the selected visual images. For example, the portable data storage medium can be taken to a store or kiosk having the appropriate computational apparatus. The print production computer program can be implemented to automatically execute upon insertion of the portable data storage medium into the data reading device and produce a user interface in accordance with description elsewhere herein that enables a user to request printing of the selected visual images

In another embodiment of the invention, if the system in which the invention is used is connected to a printer, the user has the option of printing the images on that printer.

An advantageous aspect of the invention is that some or all of the steps in requesting and producing the prints, other than, for example, the user request, user modification of the request, mailing of the finished prints by a print production site, or insertion of a portable data storage medium, “burned” in accordance with the invention, into an appropriate data reading device can be done automatically, without human intervention. The automatic operation of aspects of the invention contributes significantly to facilitating the printing of visual images in accordance with the invention.

The invention can be implemented, for example, by one or more computer programs and/or data structures including instruction(s) and/or data for accomplishing the functions of the invention. For example, such computer program(s) and/or data structures can include instruction(s) and/or data for receiving a request from a user for printing of selected visual images from a collection of visual images, selecting visual images to be printed from a collection of visual images, transmitting a print request to a print production site, and causing visual image data to be stored on a portable data storage medium. Those skilled in the art can readily implement the invention using one or more computer program(s) and/or data structures in view of the description herein.

Various embodiments of the invention have been described. The descriptions are intended to be illustrative, not limitative. Thus, it will be apparent to one skilled in the art that certain modifications may be made to the invention as described herein without departing from the scope of the claims set out below.

We claim:

1. A method for producing prints of visual images extracted from a collection of visual images, comprising the steps of:
receiving a request from a user to produce prints from the collection of visual images;
automatically identifying, in response to the request, visual images to be printed from the collection of visual images;
communicating the request to produce the prints via a network to a print production site.

2. A method as in claim 1, further comprising the step of producing the prints at the print production site.

3. A method as in claim 1, wherein the request comprises an identification of a client system used by the user to make the request.

4. A method as in claim 3, wherein the identification of the client system is used by the print production site to identify a location to which the prints are to be provided.

5. A method as in claim 4, further comprising the steps of:
producing the prints at the print production site; and
providing the prints to the location identified using the client system identification.

6. A method as in claim 1, further comprising the steps of selecting the visual images to be printed.

7. A method as in claim 6, further comprising the step of extracting the visual images to be printed from the collection of visual images.

8. A method as in claim 7, wherein the extracted visual images are stored at a client system used by the user to make the request.

9. A method as in claim 8, wherein the extracted visual images are stored on a portable data storage medium or media that can be accessed by the client system.

10. A method as in claim 8, wherein the request comprises the extracted visual images.

11. A method as in claim 7, wherein the step of automatically identifying visual images to be printed further comprises the steps of selecting and extracting.

12. A method as in claim 11, wherein the request comprises the extracted visual images.

13. A method as in claim 7, wherein indices identifying the locations of the selected visual images in the collection of visual images are stored at a client system used by the user to make the request.

14. A method as in claim 13, wherein the indices are stored on a portable data storage medium or media that can be accessed by the client system.

15. A method as in claim 13, wherein the step of automatically identifying visual images to be printed further comprises the step of extracting the selected visual images using the indices.

16. A method as in claim 15, wherein the request comprises the extracted visual images.

17. A method as in claim 7, wherein the request comprises the collection of visual images.

18. A method as in claim 17, wherein the steps of selecting and extracting are performed at the print production site.

19. A method as in claim 18, wherein the request further comprises data representing user specification of one or more parameters regarding the selection of visual images from the collection of visual images.

20. A method as in claim 17, wherein:
indices identifying the locations of the selected visual images in the collection of visual images are stored at the client system;
the request further comprises the indices; and
the step of extracting is performed at the print production site.

21. A method as in claim 7, wherein the collection of visual images is stored at the print production site.

22. A method as in claim 21, wherein the request further comprises an identification of the collection of visual images.

23. A method as in claim 22, wherein the step of extracting is performed at the print production site.

24. A method as in claim 23, wherein the request further comprises indices identifying the locations of the selected visual images in the collection of visual images.

25. A method as in claim 23, wherein the step of selecting is performed at the print production site.

26. A method as in claim 25, wherein the request further comprises data representing user specification of one or more parameters regarding the selection of visual images from the collection of visual images.

27. A method as in claim 7, wherein the extracted visual images are stored at the print production site.

28. A method as in claim 27, wherein the request further comprises an identification of the extracted visual images.

29. A method as in claim 7, wherein the step of selecting visual images further comprises the step of evaluating the collection of visual images to identify one or more characteristics of the collection of visual images.

30. A method as in claim 29, wherein the step of evaluating further comprises the step of evaluating the quality of each of the visual images in the collection of visual images.

31. A method as in claim 29, wherein the step of evaluating further comprises the step of identifying keyframes in the collection of visual images.

32. A method as in claim 3, further comprising the step of communicating an order identification to the client system via the network.

33. A method as in claim 32, further comprising the step of communicating with the print production site to modify the order, the communication comprising the order identification and one or more modifications of the order.

34. A method as in claim 33, wherein the one or more modifications comprise an addition, a deletion, or both an addition and deletion to the visual images to be printed.

35. A method as in claim 33, wherein the one or more modifications comprise a request to print a specified quantity of a specified visual image.

36. A method as in claim 33, wherein:
the identification of the client system is used by the print production site to identify a location to which the prints are to be provided; and
the one or more modifications comprise a change to the location.

37. A method as in claim 1, wherein the collection of visual images comprises a visual recording.

38. A method as in claim 1, wherein the collection of visual images comprises a collection of still images.

39. A system for producing prints of visual images extracted from a collection of visual images, comprising:
means for receiving a request from a user to produce prints from the collection of visual images;
means for automatically identifying, in response to the request, visual images to be printed from the collection of visual images;
means for communicating the request to produce the prints, together with identification of the visual images, via a network to a print production site.

40. A computer readable medium or media encoded with one or more computer programs and/or data structures for producing prints of visual images extracted from a collection of visual images, comprising:
instructions and/or data for receiving a request from a user to produce prints from the collection of visual images;
instructions and/or data for automatically identifying, in response to the request, visual images to be printed from the collection of visual images; and
instructions and/or data for communicating the request to produce the prints, together with identification of the visual images, via a network to a print production site.

41. A method for producing prints of visual images extracted from a collection of visual images, comprising the steps of:
receiving a request from a user to produce prints from the collection of visual images;
automatically identifying, in response to the request, visual images to be printed from the collection of visual images; and
storing the identified visual images, the collection of visual images and/or indices identifying the locations of the identified visual images in the collection of visual images, on a portable data storage medium or media.

42. A method as in claim 43, wherein the portable data storage medium or media comprises one or more DVDs.

43. A method as in claim 43, wherein the portable data storage medium or media comprises one or more CDs.

44. A method as in claim 41, further comprising the step of selecting the visual images to be printed.

45. A method as in claim 44, wherein the step of selecting the visual images further comprises the step of evaluating the collection of visual images to identify one or more characteristics of the collection of visual images.

46. A method as in claim 45, wherein the step of evaluating further comprises the step of evaluating the quality of each of the visual images in the collection of visual images.

47. A method as in claim 45, wherein the step of evaluating further comprises the step of identifying keyframes in the collection of visual images.

48. A method as in claim 44, further comprising the step of enabling the user to specify one or more parameters regarding the selection of visual images from the collection of visual images.

49. A method as in claim 44, further comprising the step of extracting the visual images to be printed from the collection of visual images.

50. A method as in claim 49, wherein:
the step of automatically identifying further comprises the step of extracting; and
the identified visual images are stored on the portable data storage medium or media.

51. A method as in claim 50, wherein indices identifying the locations of the selected visual images in the collection of visual images are stored at a client system on which the method is performed.

52. A method as in claim 50, wherein the step of automatically identifying further comprises the step of selecting.

53. A method as in claim 41, wherein the collection of visual images is originally represented by analog data, the method further comprising the step of digitizing the visual images to be printed.

54. A method as in claim 41, further comprising the step of storing one or more computer programs and/or data structures for producing prints of the identified visual images on the portable data storage medium or media.

55. A method as in claim 54, further comprising the step of automatically using the one or more computer programs and/or data structures, upon insertion of the portable data storage medium or media into a data reading device, to produce prints of the identified visual images.

56. A method as in claim 55, wherein the collection of visual images and indices identifying the locations of the identified visual images in the collection of visual images are stored on the portable data storage medium or media.

57. A method as in claim 56, wherein the step of using the one or more computer programs and/or data structures to produce prints further comprises the step of extracting the visual images to be printed from the collection of visual images.

58. A method as in claim 41, further comprising the step of enabling a user to add to, delete from, or both add to and delete from the visual images to be printed.

59. A method as in claim 41, further comprising the step of enabling a user to request a specified quantity of prints of a specified visual image.

60. A method as in claim 41, wherein the collection of visual images comprises a visual recording.

61. A method as in claim 41, wherein the collection of visual images comprises a collection of still images.

62. A system for producing prints of visual images extracted from a collection of visual images, comprising:
means for receiving a request from a user to produce prints from the collection of visual images;
means for automatically identifying, in response to the request, visual images to be printed from the collection of visual images;
means for storing the identified visual images, or the collection of visual images and indices identifying the locations of the identified visual images in the collection of visual images, on a portable data storage medium or media; and
means for storing one or more computer programs and/or data structures for producing prints of the identified visual images on the portable data storage medium or media.

63. A computer readable medium or media encoded with one or more computer programs and/or data structures for producing prints of visual images extracted from a collection of visual images, comprising:
instructions and/or data for receiving a request from a user to produce prints from the collection of visual images;
instructions and/or data for automatically identifying, in response to the request, visual images to be printed from the collection of visual images;
instructions and/or data for storing the identified visual images, or the collection of visual images and indices identifying the locations of the identified visual images in the collection of visual images, on a portable data storage medium or media; and
instructions and/or data for storing one or more computer programs and/or data structures for producing prints of the identified visual images on the portable data storage medium or media.

64. A method for producing prints of visual images extracted from a collection of visual images, comprising the steps of:
receiving a request from a user to produce prints from the collection of visual images; and
automatically identifying, in response to the request, visual images to be printed from the collection of visual images.

65. A method as in claim 64, wherein the request is effected by a single input to a user input apparatus.

66. A method as in claim 64, further comprising the step of producing the prints.

67. A method as in claim 64, further comprising the step of selecting the visual images to be printed.

68. A method as in claim 67, further comprising the step of extracting the selected visual images.

69. A method as in claim 68, wherein the step of automatically identifying comprises the steps of selecting and extracting.

70. A method as in claim 67, wherein the step of automatically identifying comprises the step of extracting the selected visual images using indices identifying the locations of the selected visual images in the collection of visual images.

71. A method as in claim 67, wherein the step of selecting visual images further comprises the step of evaluating the collection of visual images to identify one or more characteristics of the collection of visual images.

72. A method as in claim 71, wherein the step of evaluating further comprises the step of evaluating the quality of each of the visual images in the collection of visual images.

73. A method as in claim 71, wherein the step of evaluating further comprises the step of identifying keyframes in the collection of visual images.

74. A system for producing prints of visual images extracted from a collection of visual images, comprising:
means for receiving a request from a user to produce prints from the collection of visual images; and
means for automatically identifying, in response to the request, visual images to be printed from the collection of visual images.

75. A computer readable medium or media encoded with one or more computer programs and/or data structures for producing prints of visual images extracted from a collection of visual images, comprising:
instructions and/or data for receiving a request from a user to produce prints from the collection of visual images; and
instructions and/or data for automatically identifying, in response to the request, visual images to be printed from the collection of visual images.
